(19) United States
(12) Patent Application Publication
(10) Pub. No.: US 2003/0185312 A1
(43) Pub. Date: Oct. 2, 2003

(54) Clock recovery from a composite clock signal

(75) Inventors: Meiron Atias, Shaar-Afraim (IL); Noam Ben-Moyal, Petach Tikva (IL); Abaron Agizim, Nelanya (IL); Avi Regveni, Gevai-Shemoal (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/109,335

(22) Filed: Mar. 28, 2002

(51) Int. Cl. H04L 25/49

(52) U.S. Cl. 375/293

(57) ABSTRACT

A method for recovering a reference clock from a composite clock signal is provided. The method includes receiving the composite clock signal. First and second intermediate clock signals are generated from the composite clock signal. The first and second intermediate clock signals are combined to recover the reference clock signal.

### TECHNICAL FIELD

The present invention relates to the field of telecommunications and, in particular, to clock recovery from a composite clock signal.

### BACKGROUND

Telecommunications networks transport signals between user equipment at diverse locations. A typical telecommunications network includes a number of elements such as switches, transmission media, terminals and the like. For example, user equipment is typically connected to a switch at a central office through one of a number of common access networks, e.g., twisted pair, digital loop carrier.

To allow interoperability of equipment from various vendors, the structure and function of telecommunications equipment is typically governed by one or more standards. Some standards address the interfaces between central office equipment and equipment in the access network. These standards address a variety of parameters. One typical parameter relates to locking a clock in the access equipment to a clock provided by the central office equipment.

Bellcore standard GR-1244 requires certain access equipment to lock to a 64 kilohertz (kHz), bipolar composite clock. This clock, provided by the central office, is the combination of an 8 kHz reference clock and a 64 kHz clock. The 8 kHz reference clock is encoded into the composite clock as bipolar violations in the 64 kHz clock signal as described in the standard. Unfortunately, the standard does not describe any technique for recovering this 8 kHz signal from the 64 kHz bipolar, composite clock signal.

Therefore, there is a need in the art for recovering a reference clock from a bipolar, composite clock signal.

### SUMMARY

Embodiments of the present invention recover a reference clock signal from a bipolar, composite clock signal by creating and combining first and second signals with half the frequency of the reference clock signal. In some embodiments, the reference clock signal is recovered by generating the first signal based on positive, bipolar violations and the second signal based on negative, bipolar violations in the bipolar, composite clock signal. The first and second signals are offset in time such that when they are combined, a signal with twice the frequency of the first and second signals is generated. This signal is the recovered reference clock signal.

In one embodiment, a method for recovering a reference clock from a composite clock signal is provided. The method includes receiving the composite clock signal. First and second intermediate clock signals are generated from the composite clock signal. The first and second intermediate clock signals are combined to recover the reference clock signal.

### BRIEF DESCRIPTION OF THE DRAWINGS

FIG. 1 is a block diagram of one embodiment of a clock recovery circuit according to the teachings of the present invention.

FIGS. 2A, 2B, 2C, 2D, 2E, 2F, 2G, and 2H are timing diagrams that illustrate an example of the operation of the clock recovery circuit of FIG. 1 according to the teachings of the present invention.

FIG. 3 is a schematic diagram of one embodiment of a front end for a clock recovery circuit according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

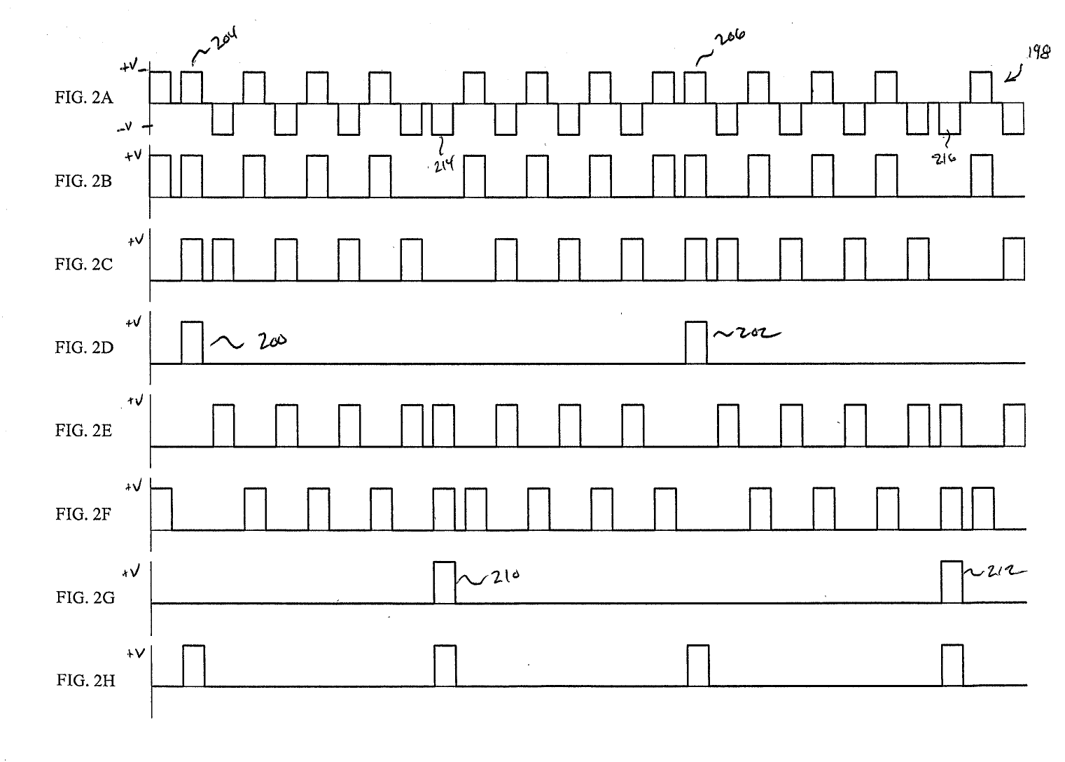

Embodiments of the present invention provide a mechanism for recovering a reference clock signal from a bipolar, composite clock signal. In one embodiment, a bipolar, composite clock signal is specified in Bellcore standard GR-1244. Under GR-1244, the clock is a composite of a 64 kHz clock signal and an 8 kHz reference clock signal. The composite clock signal is a bipolar clock signal in that the signal has alternating positive and negative pulses. The 8 kHz signal is encoded onto the 64 kHz signal as bipolar violations of the alternating negative and positive pulses. These violations take the form of consecutive positive or consecutive negative pulses. Advantageously, embodiments of the present invention recover the 8 kHz reference clock signal based on these bipolar violations by generating two intermediate signals each with half the frequency of the reference clock signal. A sample of the composite clock signal is shown and described in more detail below with respect to FIG. 2A.

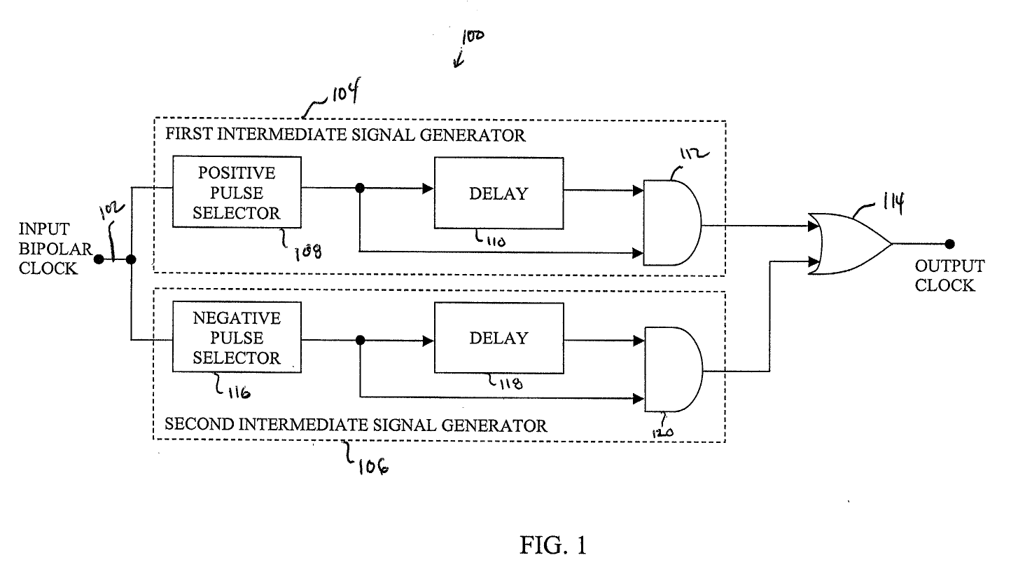

FIG. 1 is a block diagram of one embodiment of a clock recovery circuit, indicated at 100, according to the teachings of the present invention. In one embodiment, circuit 100 is used to synchronize between an optical network and a central office. In one embodiment, circuit 100 is implemented using passive devices and a complex programmable logic device (CPLD).

Circuit 100 includes port 102 for receiving a composite clock signal such as composite clock signal 198 shown in FIG. 2A. In one embodiment, clock signal 198 of FIG. 2A comprises a clock signal generated at a central office according to Bellcore standard GR-1244. In one embodiment, the composite clock signal is a 64 kHz, ⅝ duty cycle, return-to-zero, bipolar signal with bipolar violations (positive or negative) every eighth bit. For purposes of this specification, the term “bipolar violation” means consecutive negative or consecutive positive pulses in a bipolar signal that normally alternates between negative and positive pulses. In other embodiments, the signal received at port 102 comprises other appropriate clock signals. Port 102 is coupled to first and second intermediate signal generators 104 and 106, respectively.

First intermediate signal generator 104 receives the composite clock signal from port 102 and produces an intermediate signal with half the frequency of the recovered clock signal. First intermediate signal generator 104 include positive pulse selector 108. Positive pulse selector 108 selects the positive pulses in the composite clock signal. A sample output of positive pulse selector 108 is shown in FIG. 2B.

Positive pulse selector 108 is coupled to delay 110 to generate a delayed set of positive pulses. In one embodiment, delay 110 is a D flip-flop that is triggered by the composite clock signal, e.g., the 64 kHz signal. In other embodiments, delay 110 is implemented as a delay line or other delay element. Delay 110 shifts the selected positive pulses by the duration of one pulse in clock signal 198. A sample output of delay 110 is shown by way of example in FIG. 2C.

First intermediate signal generator 104 generates the first intermediate signal based on the output of positive pulse selector 108 and delay 110. Delay 110 is coupled to AND gate 112. AND gate 112 is also coupled to the output of positive pulse selector 108. As shown in FIG. 2C at 200 and 202, AND gate 112 outputs a positive pulse when both the signal from positive pulse selector 108 and the delayed signal from delay 110 provide a positive pulse. This occurs at the positive pulse violations in the composite clock signal of FIG. 2A (204 and 206). The output of first intermediate signal generator 104 is provided to OR gate 114.

Second intermediate signal generator 106 receives the composite clock signal from port 102 and produces an intermediate signal with half the frequency of the recovered clock signal. The output of second intermediate signal generator 106 is offset from the output of the first intermediate signal generator in that the first and second intermediate signal generators produce pulses at different times based on different parts of the composite clock signal. Second intermediate signal generator 106 includes negative pulse selector 116. Negative pulse selector 108 selects and takes the absolute value of the negative pulses in the composite clock signal. A sample output of negative pulse selector 116 is shown in FIG. 2E.

Negative pulse selector 116 is coupled to delay 118 to generate a delayed set of pulses. In one embodiment, delay 118 is a D flip-flop that is triggered by the composite clock signal, e.g., the 64 kHz signal. In other embodiments, delay 118 is implemented as a delay line or other delay element. Delay 118 shifts the selected positive pulses by the duration of one pulse in clock signal 198. A sample output of delay 118 is shown by way of example in FIG. 2F.

Second intermediate signal generator 106 generates the second intermediate signal based on the output of negative pulse selector 116 and delay 118. Delay 118 is coupled to AND gate 120. AND gate 120 is also coupled to the output of negative pulse selector 116. As shown in FIG. 2G at 210 and 212, AND gate 120 outputs a pulse when both the signal from negative pulse selector 116 and the delayed signal from delay 118 provide a pulse. This occurs at the negative pulse violations in the composite clock signal of FIG. 2A (214 and 216). The output of second intermediate signal generator 106 is also provided to OR gate 114.

OR gate 114 combines the signals from first and second intermediate signal generators 104 and 106, respectively, and thereby produces the recovered clock signal.

In operation, clock recovery circuit 100 recovers a clock signal from an input clock signal received at port 102. The input clock is fed to first and second intermediate signal generators 104 and 106. First and second intermediate signal generators 104 and 106 generate signals with half the frequency of the recovered clock signal. The intermediate signals are offset such that when they are combined, the resultant signal comprises the recovered clock signal with a frequency that is twice the frequency of the intermediate signals.

The intermediate signals are generated based on bipolar violations in the composite clock signal. The violations are detected by comparison of positive or negative pulses of the composite signal with a delayed signal. The delayed signal includes bipolar violations that overlap with the original signal. These bipolar violations thus produce the intermediate signal with pulses at a frequency that is half the target frequency of the recovered clock signal.

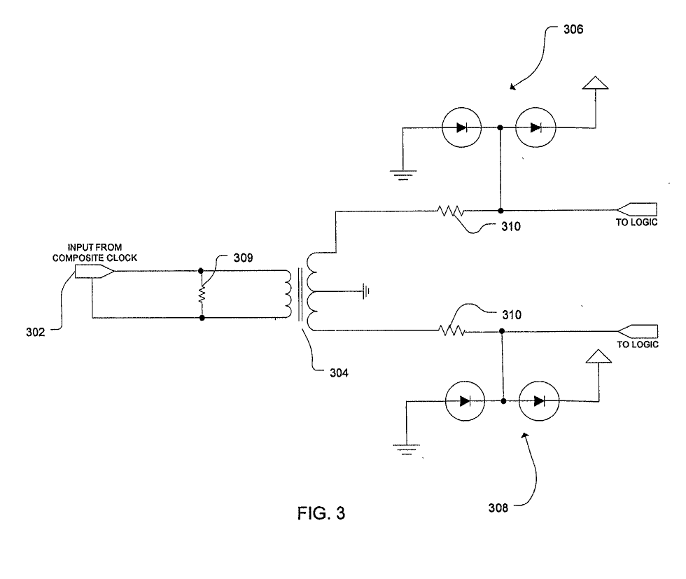

FIG. 3 is a schematic diagram of a front end, indicated generally at 300, for a clock recovery circuit according to the teachings of the present invention. Front end 300 includes port 302 for receiving the composite clock signal and transformer 304 that isolates following logic units from potentially hazardous cable line carrying the composite clock and provides two mutually inverted inputs to the logic. Front end 300 further includes diode circuits 306 and 308 that limit the signals on the logic inputs to exclude overdrive. Resistor 309 provides proper impedance matching to the cable line carrying the composite clock. Resistors 310 prevent unacceptable impedance changes when any of the diodes in diode circuits 306, 308 is conducting. The output of transformer 304 is provided to a logic circuit to implement the functions described above with respect to FIG. 1.

What is claimed is:

1. A method for recovering a reference clock from a composite clock signal, the method comprising:
receiving the composite clock signal;
generating a first intermediate clock signal;
generating a second intermediate clock signal; and
combining the first and second intermediate clock signals to recover the reference clock signal.

2. The method of claim 1, wherein receiving a composite clock signal comprises receiving a 64 kHz composite clock signal with a bipolar violation every eighth bit.

3. The method of claim 1, wherein receiving a composite clock signal comprises receiving a bipolar clock signal generated from a 64 kHz clock and an 8 kHz clock signal.

4. The method of claim 1, wherein generating a first intermediate clock signal comprises generating a first clock signal with a frequency that is one-half of the frequency of the reference clock signal.

5. The method of claim 4, wherein generating a second intermediate clock signal comprises generating a second clock signal with a frequency that is one-half of the frequency of the reference clock signal, the second clock signal offset from the first clock signal.

6. The method of claim 5, wherein combining the first and second intermediate clock signals comprises combining the first and second intermediate clock signals through a logic OR gate.

7. The method of claim 1, wherein generating a first intermediate clock signal comprises:
selecting positive pulses in the composite clock signal;
shifting the selected positive pulses; and
comparing the selected positive pulses with the shifted, selected positive pulses to produce the first intermediate clock signal with pulses corresponding to positive bipolar violations in the composite clock signal.

8. The method of claim 1, wherein generating a second intermediate clock signal comprises:
selecting negative pulses in the composite clock signal;
shifting the selected negative pulses; and
comparing the selected negative pulses with the shifted, selected negative pulses to produce the second intermediate clock signal with pulses corresponding to negative bipolar violations in the composite clock signal.

9. A method for recovering a reference clock signal from a bipolar composite clock signal with bipolar violations at a selected interval related to the reference clock signal, the method comprising:
receiving the bipolar composite clock signal;
generating a first intermediate signal based on positive pulse violations in the composite clock signal;
generating a second intermediate signal based on negative pulse violations in the composite clock signal; and
combining the first and second intermediate signals.

10. The method of claim 9, wherein receiving a composite clock signal comprises receiving a 64 kHz composite clock signal with a bipolar violation every eighth bit.

11. The method of claim 9, wherein receiving a composite clock signal comprises receiving a bipolar clock signal generated from a 64 kHz clock and an 8 kHz clock signal.

12. The method of claim 9, wherein generating a first intermediate signal comprises generating a first signal with a frequency that is one-half of the frequency of the reference clock signal.

13. The method of claim 12, wherein generating a second intermediate signal comprises generating a second signal with a frequency that is one-half of the frequency of the reference clock signal, the second signal offset from the first signal.

14. The method of claim 13, wherein combining the first and second intermediate signals comprises combining the first and second intermediate signals through a logic OR gate.

15. The method of claim 9, wherein generating a first intermediate signal comprises:
selecting positive pulses in the composite clock signal;
shifting the selected positive pulses; and
comparing the selected positive pulses with the shifted, selected positive pulses to produce the first intermediate signal with pulses corresponding to positive bipolar violations in the composite clock signal.

16. The method of claim 9, wherein generating a second intermediate signal comprises:
selecting negative pulses in the composite clock signal;
shifting the selected negative pulses; and
comparing the selected negative pulses with the shifted, selected negative pulses to produce the second intermediate signal with pulses corresponding to negative bipolar violations in the composite clock signal.

17. A method for recovering a reference clock signal having a first frequency from a bipolar composite clock signal having a second frequency, wherein the composite clock signal has bipolar violations at a selected interval related to the reference clock signal, the method comprising:
receiving the bipolar composite clock signal;
generating a first intermediate signal with half the frequency of the reference clock signal based on a first set of violations in the composite clock signal;
generating a second intermediate signal with half the frequency of the reference clock signal based on a second set of violations in the composite clock signal; and
combining the first and second intermediate signals.

18. The method of claim 17, wherein receiving a composite clock signal comprises receiving a 64 kHz composite clock signal with a bipolar violation every eighth bit.

19. The method of claim 17, wherein receiving a composite clock signal comprises receiving a bipolar clock signal generated from a 64 kHz clock and an 8 kHz clock signal.

20. A clock recovery method, comprising:
receiving a bipolar composite clock with spaced-apart bipolar violations;
generating a first signal from positive pulses in the bipolar composite clock;
delaying the first signal;
producing a first intermediate signal from the first signal and the delayed first signal;
generating a second signal from the negative pulses in the bipolar composite clock;
delaying the second signal;
producing a second intermediate signal from the second signal and the delayed second signal; and
combining the first and second intermediate signals.

21. The method of claim 20, wherein receiving a bipolar composite clock with spaced-apart bipolar violations comprises receiving a bipolar composite clock with bipolar violations every eighth bits.

22. A clock recovery circuit, comprising:
a port adapted to receive a bipolar composite clock signal;
a first intermediate signal generator, responsive to the port, and adapted to produce a first intermediate signal based on a first set of bipolar violations in the composite clock signal;
a second intermediate signal generator, responsive to the port, and adapted to produce a second intermediate signal based on a second set of bipolar violations in the composite clock signal;
a logic circuit, responsive to the first and second intermediate signal generators, that combines the first and second intermediate signals to produce a recovered clock signal.

23. The clock recovery circuit of claim 22, wherein the first intermediate signal generator comprises:
a pulse selector circuit, coupled to the port, and adapted to select the positive pulses in the bipolar composite clock signal;
a delay, coupled to the pulse selector, adapted to provide a delayed copy of the output of the pulse selector circuit; and
an AND gate, coupled to the pulse selector circuit and the delay, the AND gate producing the first intermediate signal based on the selected positive pulses and the delayed copy of the output of the pulse selector circuit.

24. The clock recovery circuit of claim 23, wherein the second intermediate signal generator comprises:
a pulse selector circuit, coupled to the port, and adapted to select the negative pulses in the bipolar composite clock signal;
a delay, coupled to the pulse selector, adapted to provide a delayed copy of the output of the pulse selector circuit; and
an AND gate, coupled to the pulse selector circuit and the delay, the AND gate producing the second intermediate signal based on the selected negative pulses and the delayed copy of the output of the pulse selector circuit.

25. The clock recovery circuit of claim 22, wherein the logic circuit comprises an OR gate.

26. The clock recovery circuit of claim 22, wherein the first intermediate signal generator comprises a circuit that produces the first intermediate signal with a frequency that is one-half of the frequency of the recovered clock signal

27. The clock recovery circuit of claim 26, wherein the second intermediate signal generator comprises a circuit that produces the second intermediate signal with a frequency that is one-half of the frequency of the recovered clock signal and is offset from the first intermediate signal.

28. A clock recovery circuit, comprising:
a port adapted to receive a bipolar composite clock signal;
a first intermediate signal generator, responsive to the port, and adapted to produce a first intermediate signal with half the frequency of a recovered clock signal based on positive bipolar violation in the composite clock signal;
a second intermediate signal generator, responsive to the port, and adapted to produce a second intermediate signal with half the frequency of the recovered clock signal based on negative bipolar violations in the composite clock signal, the second intermediate signal being offset from the first intermediate signal; and
a logic circuit, responsive to the first and second intermediate signal generators, that combines the first and second intermediate signals to produce the recovered clock signal.
